(19) United States
(12) Patent Application Publication
(10) Pub. No.: US 2023/0093108 A1
(43) Pub. Date: Mar. 23, 2023

(54) SYSTEMS AND METHODS FOR MICROWAVE REMOVAL OF NH3 FROM ADSORBENT MATERIAL

(71) Applicant: STARFIRE ENERGY, Denver, CO (US)

(72) Inventors: Joseph D. BEACH, Aurora, CO (US); Adam W. WELCH, Aurora, CO (US); Jonathan D. KINTNER, Aurora, CO (US)

(21) Appl. No.: 17/904,582

(22) PCT Filed: Feb. 19, 2021
(86) PCT No.: PCT/US21/18747

§ 371 Date: Aug. 18, 2022

Related U.S. Application Data
(60) Provisional application No. 62/980,090, filed on Feb. 21, 2020.

(51) Int. Cl. C01C 1/12; B01J 19/12; B01J 20/18; B01J 20/34; B01J 8/02

(52) U.S. Cl. CPC C01C 1/12; B01J 19/126; B01J 20/18; B01J 20/3441; B01J 8/0207

(57) ABSTRACT

Method and systems for desorbing NH₃ from an NH₃-adsorbent material by exposing the adsorbent material to microwave radiation are described. Also described are methods for increasing an NH₃ cracker's NH₃ utilization and reducing the chance of downstream process contamination. Also described are methods of producing high pressure, high purity H₂ from NH₃.

### CROSS-REFERENCE TO RELATED APPLICATION(S)

The present application claims priority under 35 U.S.C. § 119(e) to U.S. Provisional Patent Application No. 62/980,090, filed Feb. 21, 2020, the entirety of which is hereby incorporated by reference.

### TECHNICAL FIELD

The technology described herein generally relates systems and methods for removing adsorbed NH₃ from an adsorbent material by exposing it to microwaves and recovering the released NH₃. NH₃ recovered in this manner can be re-used or stored for later use.

### BACKGROUND

Human-caused emissions of carbon dioxide (CO₂) are causing global warming, climate changes, and ocean acidification. These threaten humanity's continued economic development and security. To counter this threat, energy sources that are substantially free of CO₂ emissions are highly sought after in both industrialized and developing countries. While several CO₂-free energy generation options have been extensively developed, none presently include a practicable CO₂-free fuel.

Ammonia (NH₃) can be burned as a fuel according to the following reaction equation (1):

4NH₃(g)+3O₂→2N₂+6H₂O(g)+heat (1)

NH₃ can be used directly as a carbon-free fuel or as a hydrogen source if it is reformed into hydrogen and nitrogen gases. It can also be used in a mixture of NH₃, H₂, and N₂ to tailor its combustion characteristics to specific processes or equipment. It has a higher energy density, easier storage conditions, and cheaper long-term storage and distribution than gaseous hydrogen, liquid hydrogen, or batteries.

The main industrial procedure for the production of ammonia is the Haber-Bosch process, illustrated in the following reaction equation (2):

N₂(g)+3H₂(g)→2NH₃(g)(ΔH=−92.2 kJ/mol) (2)

In 2005, Haber-Bosch ammonia synthesis produced an average of about 2.1 tonnes of CO₂, per tonne of NH₃ produced. About two thirds of the CO₂ production derives from the steam reforming with hydrocarbons to produce hydrogen gas, while the remaining third derives from hydrocarbon fuel combustion to provide energy to the synthesis plant. As of 2005, about 75% of Haber-Bosch NH₃ plants used natural gas as feed and fuel, while the remainder used coal or petroleum. Haber-Bosch NH₃ synthesis consumed about 3% to 5% of global natural gas production and about 1% to 2% of global energy production.

The Haber-Bosch reaction is generally carried out in a reactor containing an iron oxide or a ruthenium catalyst at a temperature of between about 300° C. and about 550° C. and at a pressure of between about 90 bar and about 180 bar. The elevated temperature is required to achieve a reasonable reaction rate. Due to the exothermic nature of NH₃ synthesis, the elevated temperature drives the equilibrium toward the reactants, but this is counteracted by the high pressure.

Recent advances in ammonia synthesis have yielded reactors that can operate at temperatures between about 300° C. and about 600° C. and pressures ranging from 1 bar up to the practical limits of pressure vessel and compressor design. When designed for lower operating pressures, this newer generation of reactors can reduce equipment costs and gas compression costs, but they also reduce the fraction of the N₂ and H₂ reactants converted to NH₃ during each pass through the catalyst bed. Rather than liquefying the NH₃ to remove it from the product stream, these reactors use an adsorbent material to achieve a gas phase NH₃ removal as described in U.S. Pat. No. 10,787,367, the entirety of which is hereby incorporated by reference.

The gas phase removal of NH₃ from the reactor product stream is highly advantageous because it allows the reactor to be operated at a broad range of pressures, flows, and temperatures. However, the ammonia must be removed from the adsorbent material in pure form for subsequent liquefaction and storage. U.S. Pat. No. 10,787,367 describes a thermally driven method for removing the NH₃ from the adsorbent. While this is effective, it can be a relatively slow process because the adsorbent material has low thermal conductivity. A faster NH₃ desorption process would allow the use of smaller adsorption beds, which can reduce capital cost and reactor footprint.

NH₃ is a cost-effective way to store and deliver hydrogen fuel to equipment, but certain NH₃-fueled equipment require hydrogen purity over 99.999% and have low tolerance for NH₃ impurities. The chemical thermodynamics of ammonia are such that cracking NH₃ yields a mixture of N₂+H₂+NH₃ with 10's to 1000's of ppm of residual NH₃, which is too high for proton exchange membrane fuel cells and similar devices. Residual NH₃ can be removed from the cracked gas stream by passing it though a bed of material that adsorbs the NH₃ but lets the N₂ and H₂ pass through. While U.S. Pat. No. 10,787,367 describes a related process, the NH₃ captured by the adsorbent material must be removed periodically so that the adsorbent bed can continue to be used. An NH₃ removal method that is faster than traditional thermal desorption is desirable.

Recently developed NH₃ synthesis reactors and NH₃ cracking reactors for NH₃ fuel expose a need in the field for a method to remove adsorbed NH₃ from an adsorbent material that is faster and more thorough than traditional thermal regeneration.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a method for desorbing ammonia from an adsorbent material includes the steps of providing an adsorbent material having ammonia adsorbed therein, and exposing the adsorbent material to microwave radiation to thereby desorb ammonia from the adsorbent material. In some embodiments, the method can further include removing desorbed ammonia from the adsorbent material, such as through the use of a sweep gas or a vacuum pump. Microwave radiation can be directed at the adsorbent material continuously or in phases. The photon energy of the microwave radiation can be changed during the process of exposing the adsorbent material to microwave radiation.

In some embodiments, an apparatus for removing ammonia from an adsorbent material includes an adsorbent vessel, an adsorbent material disposed within the adsorbent vessel, the adsorbent material having ammonia adsorbed therein, and a microwave emitter configured to direct microwave radiation at the adsorbent material disposed in the adsorbent vessel. The microwave emitter can be located inside or outside of the adsorbent vessel. In some embodiments, the apparatus includes a plurality of microwave emitters. The microwave emitters may have launchers associated therewith to direct the microwave radiation into the adsorbent vessel in a desired direction.

### BRIEF DESCRIPTION OF THE DRAWINGS

Non-limiting and non-exhaustive embodiments of the disclosed systems and methods, including the preferred embodiment, are described with reference to the following figures, wherein like reference numerals refer to like parts throughout the various views unless otherwise specified.

FIG. 1 is a side cross-sectional schematic illustration of a system for removing NH₃ from an adsorbent material according to various embodiments described herein.

FIG. 2 is a side cross-sectional schematic illustration of a system for removing NH₃ from an adsorbent material according to various embodiments described herein.

FIG. 3 is a side cross-sectional schematic illustration of a system for removing NH₃ from an adsorbent material according to various embodiments described herein.

FIG. 4 is a side cross-sectional schematic illustration of a system for removing NH₃ from an adsorbent material according to various embodiments described herein.

FIG. 5 is a side cross-sectional schematic illustration of a system for removing NH₃ from an adsorbent material according to various embodiments described herein.

FIG. 6 is top-down cross-sectional schematic illustration of a system for removing NH₃ from an adsorbent material according to various embodiments described herein.

FIG. 7 is schematic and block diagram of a “microwave tube furnace” built to test microwave-induced NH₃ desorption and removal by a sweep gas according to various embodiments described herein.

FIG. 8 is a graph of collected NH₃ over time using the apparatus depicted in FIG. 7.

FIG. 9 is a block diagram of a microwave tube furnace modified to test microwave-induced NH₃ desorption and removal by a vacuum pump according to various embodiments described herein.

FIG. 10 is a schematic and block diagram of an apparatus used to test microwave-induced desorption of ammonia with an external microwave source directed through a window on the end of the adsorber vessel according to various embodiments described herein.

FIG. 11 is a graph of nominal microwave power and accumulator vessel fill percentage as a function of time during microwave-induced desorption testing using an external microwave source directed through a window on the end of the adsorber vessel in accordance with various embodiments described herein.

FIG. 12 is a schematic and block diagram of an apparatus used to test microwave-induced desorption of ammonia with an external microwave source directed through a window on a 45 degree angle arm in accordance with various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

U.S. Pat. No. 10,787,367, entitled “Removal of Gaseous NH₃ from an NH₃ Reactor Product Stream”, describes, among other things, various embodiments of a method for harvesting gaseous NH₃ from a NH₃ reactor product stream using an adsorbent material. For example, NH₃ gas can be removed from a gas mixture such as H₂+N₂+NH₃ by passing the mixture through an adsorption bed composed of NH₃-adsorbing material such as type 4A molecular sieve, type 5A molecular sieve, or type 13X molecular sieve. The NH₃ adsorbs to the molecular sieve in preference to the H₂ and N₂, with the net effect that the H₂ and N₂ pass through the bed while the NH₃ stays attached to the adsorbent material.

U.S. Pat. No. 10,787,367 describes removing adsorbed NH₃ from an adsorbent material using a thermally-driven temperature and pressure swing process. This application, in contrast, describes using microwave radiation (optionally in combination with vacuum pumps) to remove the NH₃ from the adsorbent material.

NH₃ Desorption by Microwave Radiation

In some embodiments described herein, a method of desorbing NH₃ from an adsorbent material generally comprises exposing the absorbent material having NH₃ contained therein to microwave radiation. Any suitable type of microwave radiation can be used, including at any suitable frequency. In some embodiments, the frequency of the microwave radiation used in the methods described herein is 2.45 gigahertz (GHz) (the frequency used in typical residential microwave ovens). However, it should be appreciated that other frequencies, such as the 915 MHz frequency used in industrial microwave ovens, can also be used in the methods described herein.

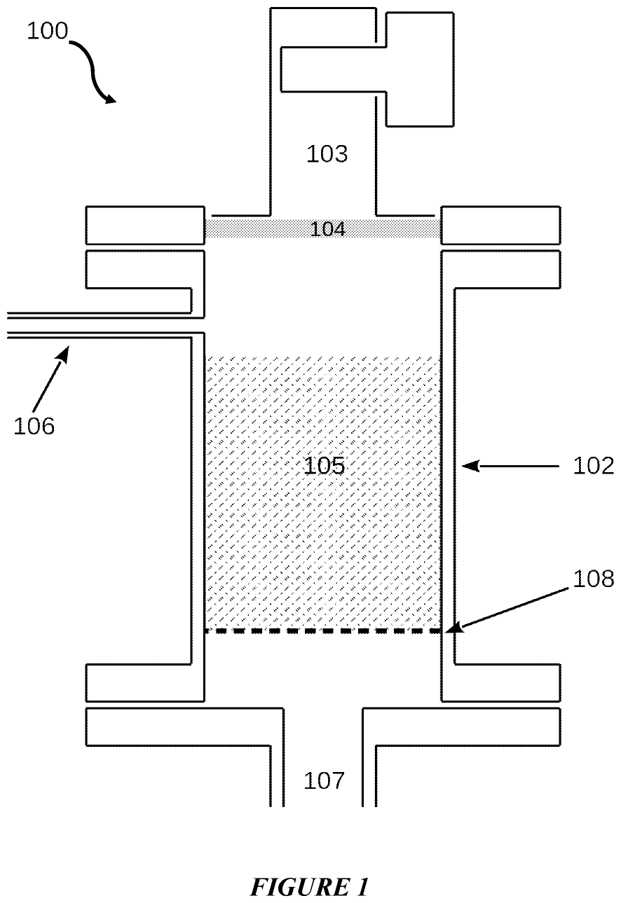

The specific manner of directing microwave radiation at an absorbent material loaded with adsorbed NH₃ or generally exposing the adsorbent material to microwave radiation is generally not limited, provided that the adsorbent material is sufficiently exposed to the microwave radiation such that the NH₃ is desorbed from the adsorbent material. Specific configurations of sources of microwave radiation relative to the location of the adsorbent material are described in further detail below with respect to, e.g., FIGS. 1-6. It should also be appreciated that multiple configurations can be used to improve the removal of NH₃ from the adsorbent material. For example, a method may include applying microwave radiation to an adsorbent material from a first direction, angle, and/or distance, followed by applying microwave radiation to the adsorbent material from a second direction, angle and/or distance different from the first direction, angle, and or distance. Similarly, microwave radiation may be applied to an adsorbent material simultaneously from different directions, angles, and/or distances.

The amount of time that the adsorbent material is exposed to microwave radiation in the methods described herein is generally not limited. In some embodiments, the microwave radiation may be applied to the adsorbent material for any period of time that removes some or all NH₃ from the adsorbent material.

Thermogravimetric analysis of NH₃ desorption from type 13X adsorbent material indicates that it has a range of adsorption energies. Using a photon model of microwave desorption of NH₃ that is analogous to electron photoemission, NH₃ bonded to low energy sites should be desorbed by longer wavelength (lower photon energy) microwaves than NH₃ bonded to high energy sites. Using high energy microwave photons to desorb NH₃ from low energy sites will result in NH₃ heating, which is not a good use of the microwave energy. As such, heating during desorption can be minimized by first using low photon energy microwaves to desorb the NH₃ from low energy sites, and then progress to higher photon energy microwaves to desorb the NH₃ higher energy sites. This can be done with either a set of fixed-frequency microwave sources or with a variable frequency microwave source.

While not wishing to be bound by theory, a possible explanation for the desorption effect microwave radiation exhibits when directed at an adsorbent material containing NH₃ is that the dipole moment of the adsorbed NH₃ is large enough that the microwaves can cause the molecule to twist or rotate on the adsorbent surface with sufficient force or energy to break the adsorption bonding and free the molecule from the surface.

The microwave NH₃ desorption methods described herein can offer much faster adsorbent regeneration times than traditional thermal regeneration because the adsorbent material does not readily absorb microwaves. The microwaves are only absorbed by the NH₃ molecules, which concentrates the microwave energy on the adsorbed NH₃ instead of dispersing it through the entire mass of the adsorption bed. This concentration of the energy on the NH₃ molecules causes them to detach from the surface much more quickly than if thermal energy had to conduct through the entire adsorption bed, which has very poor thermal conductivity.

Microwave Desorbed NH3 Removal with Sweep Gas

Once desorbed from the adsorbent material, the methods described herein may require additional steps and/or processing in order to remove the desorbed NH₃ from within the adsorbent material. In some embodiments, such removal may be accomplished with the use of a non-reactive sweep gas. More specifically, the NH₃ that has been desorbed from an adsorbent material by microwaves can be removed from the adsorbent bed by flowing a non-reactive sweep gas through the bed. The sweep gas entrains the desorbed NH₃ molecules and carries them out of the adsorption bed. In such embodiments, the desorbed NH₃ is removed from the adsorption bed as a mixture of NH₃ and the sweep gas. Preferably, the sweep gas does not absorb microwave energy, so that it does not interfere with the microwaves being absorbed by the NH₃ molecules. Non-limiting examples of a suitable sweep gas are nitrogen, hydrogen, and air. Flowing sweep gas through the adsorbent material can be performed while microwave radiation is being directed at the adsorbent material or after the completion of exposing the adsorbent material to the microwave radiation.

Microwave Desorbed NH₃ Removal as a Pure Gas with a Vacuum Pump

In some embodiments, it is desirable to remove the NH₃ from the adsorbent material as a pure gas. In such embodiments, a vacuum pump can be used to (a) remove interstitial gases from the adsorbent bed prior to microwave exposure, and (b) remove the NH₃ from the adsorbent bed as it is desorbed by microwaves. The vacuum pump can also be used to remove the NH₃ from the adsorbent bed after the adsorbent material has been exposed to microwaves, or both during and after the exposure of the adsorbent material to microwave radiation. In some embodiments, the pure NH₃ gas thus removed from the adsorbent bed can be directed to an accumulator vessel or bladder and then pumped into a storage vessel where it can be stored as either a compressed gas, pressurized liquid, or chilled liquid.

Re-Use of Harvested NH₃ in Cracker

In some embodiments, an NH₃-adsorbent bed is used to remove residual NH₃ from a cracked NH₃ gas stream consisting of H₂, N₂, and NH₃. The N₂ and H₂ pass through the adsorbent bed to downstream processes, while the NH₃ is adsorbed by the bed. In such embodiments, the adsorbent bed can be regenerated by a method that produces a pure NH₃ gas stream that can be directed to the upstream NH₃ cracker. This increases the NH₃ utilization and prevents venting of NH₃ to the atmosphere.

Conversion of NH₃ to Pressurized, Pure H₂

In some embodiments, it is desirable to use NH₃ to produce high purity, pressurized hydrogen. In some embodiments, “high purity” as used herein means greater than 99.8% H₂. In such embodiments, NH₃ can be cracked to produce an H₂+N₂+NH₃ mixture. An adsorption bed can be used to remove the residual NH₃ from the cracked gas stream and thus provide a gas stream consisting of N₂ and H₂ with less than 10 ppm NH₃ and possibly less than 1 ppm NH₃. The N₂+H₂ gas stream can be directed to an electrochemical purifier and compressor to produce high purity, high pressure hydrogen. In some embodiments, the pressure may be as high as 13,000 psig. Examples of electrochemical hydrogen purification and compression equipment are apparatus produced by HyET Hydrogen. In those examples, the purifier and compressor both use proton exchange membrane material that can be damaged by NH₃ impurities in the incoming N₂+H₂ gas stream.

Systems for Applying Microwave Radiation to Adsorbent Material

As described previously, the methods described herein generally include the application of microwave radiation to adsorbent material having NH₃ adsorbed therein. Various systems and apparatus can be provided to carry out this step. FIGS. 1-6 described in greater detail below present various configurations for such systems and apparatus.

Microwave Source Located Outside of Adsorption Bed

In some embodiments, a system is provided wherein the microwave source is located outside of the adsorption bed. Such configurations may be useful when, e.g., the microwave source is built from materials not compatible with NH₃ or other gases that will flow through the adsorption bed, or when the microwave source is not compatible with the pressures present in the adsorption bed.

FIG. 1 depicts an apparatus 100 comprising an adsorber vessel 102. The adsorber vessel 102 generally has a hollow interior where an absorbent material 105 can be positioned. As shown in FIG. 1, the adsorber vessel 102 has a generally elongated cylindrical shape with the longitudinal axis of the adsorber vessel 102 being oriented generally vertically. However, it should be appreciated that other adsorber vessel shapes and orientations may be used.

In the embodiment shown in FIG. 1, a microwave source 101 is located outside of the adsorber vessel 102, such as just outside the top end of the adsorber vessel 102. The microwaves generated by the microwave source 101 are directed by a launcher 103 to pass through a microwave-transparent window 104 located at the top of the adsorber vessel 102 and thus into the adsorption vessel 102. The microwaves then propagate through the adsorbent material 105 loaded in the adsorption vessel 102, causing the adsorbed ammonia within the adsorbent material 105 to desorb. This may occur with the adsorption vessel 102 being either under vacuum or being exposed to a sweep gas.

In some embodiments, the adsorbent material 105 is supported by a perforated plate 108 located within the adsorption vessel 102. The perforations in the plate 108 allow gas to flow though the plate 108. In this manner, desorbed NH₃ removed from the adsorbent material 105 can flow through the plate 108 and towards the gas outlet port 107. The location of the perforated plate 108 can be adjusted such that the adsorbent material 105 positioned on the plate 108 can be moved closer to or farther away from the microwave source 101.

The adsorber vessel 102 is equipped with a gas inlet port 106 and a gas outlet port 107 such that gas can be flowed into and out of the adsorber vessel 102. As mentioned previously, removal of desorbed NH₃ from the adsorbent material 105 and the adsorber vessel 102 can be facilitated with the use of, e.g., a sweep gas. This sweep gas can be introduced into the adsorber vessel via inlet port 106, and sweep gas with desorbed NH₃ entrained therein can be removed from the adsorber vessel 102 via outlet port 107. While FIG. 1 shows inlet port 106 oriented perpendicular to the longitudinal axis of the adsorber vessel 102 at proximate the upper end of the adsorber vessel and outlet port 107 oriented parallel to the longitudinal axis of the adsorber vessel 102 and at the bottom end of the adsorber vessel 102, it should be appreciated that the location and orientation of these inlet and outlet ports 106/107 is not limited. Additionally, the number of inlet and outlet ports 106/107 can be varied.

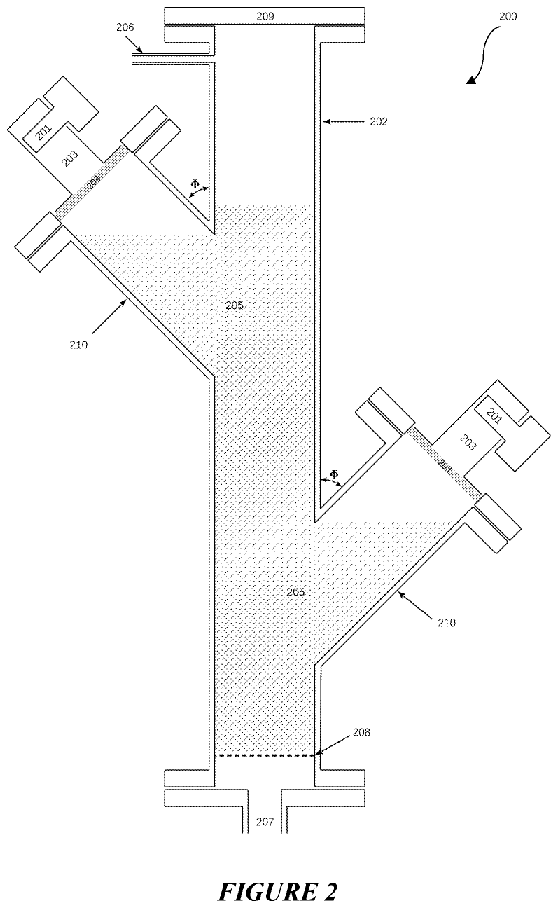

A single microwave source located at one end of the adsorbent vessel may not be able to propagate through the adsorbent material with sufficient intensity to desorb the ammonia on the adsorbent material at the far end of the adsorbent vessel. Accordingly, some embodiments may include multiple microwave sources located along the length of the adsorbent vessel to ensure that all regions of the adsorbent material receive sufficient microwave exposure for the ammonia to desorb. FIG. 2 depicts an apparatus 200 with multiple microwave sources 201 located on angled pipe sections 210 positioned along the length of the adsorbent vessel 202. Each microwave source 201 has a corresponding launcher 203 such that microwaves from the microwave sources 201 are directed to pass through a microwave-transparent window 204 associated with each angled pipe section 210. In this manner, microwaves enter the adsorber vessel 202 via angled pipe sections 210 and interact with adsorbent material 205 positioned within the adsorber material.

The angle Φ of the angled pipe sections 210 allows the microwaves to enter the main body of the adsorbent vessel 202 and continue to propagate down its length. This embodiment allows microwave regeneration to be used on adsorbent vessels of arbitrary length. Angle Φ is generally not limited, though is some embodiments, it is preferable that angle Φ be less than 90 degrees such that microwaves are transmitted into the adsorber vessel 202 in a direction that increases the likelihood that the microwaves will engage with the adsorbent material 205 and continue to propagate through the adsorbent material 205 in a direction towards the outlet port 207.

In another embodiment not shown in the Figures, the configurations shown in FIGS. 1 and 2 can be combined. In such an embodiment, an additional microwave emitter and window would be located above the top flange 209 of the apparatus 200 shown in FIG. 2, thus allowing the adsorbent material located above the first angled pipe section 210 to be regenerated.

As with the apparatus 100 shown in FIG. 1 and described in greater detail above, various features of the apparatus 200 can be adjusted, such as the location, orientation, and number of the inlet and outlet ports 206/207, the shape, size and orientation of the adsorber vessel 202, etc., as well as other features, such as the number, location and orientation of the of angled pipe sections 210.

Microwave Source Mounted in Isolated Interior Section

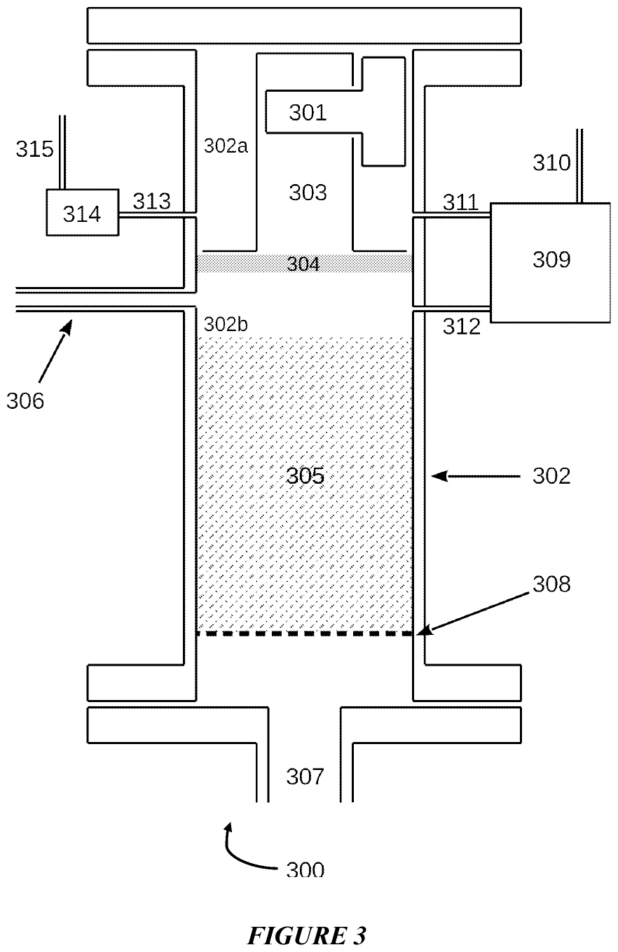

In some embodiments, the microwave source is located inside the adsorbent vessel. This can be challenging if the microwave source components are sensitive to ammonia gas, such as copper alloys, zinc alloys, and certain rubbers. Thus, in some embodiments where the microwave source is located inside the adsorber vessel, the microwave source can be located inside an isolated section within the adsorber vessel as depicted in FIG. 3.

In the apparatus 300 depicted in FIG. 3, the top portion 302a of the adsorbent vessel 302 is separated from the lower portion 302b of the vessel 302 by a microwave-transmitting window 304 capable of withstanding a small overpressure (e.g., 1-10 psid) in the top section 302a relative to the bottom section 302b. The microwave source 301 is located in the top section 302a and is isolated from the bottom section 302b by virtue of the window 304.

Microwaves from the emitter 301 are directed by a launcher 303 to pass through the window 304 and propagate through the adsorbent material 305 loaded in the adsorbent vessel 302. The adsorbent material 305 is supported by a perforated plate 308. A differential pressure regulator 309 is set to maintain the selected overpressure in the top section 302a. A high-pressure purge gas is provided to the differential pressure regulator 309 via a tube 310. The differential pressure regulator 309 directs the purge gas to an output tube 311 at a reduced pressure equal to the sum of the pressure in its reference gas line 312 plus a preset value that can be adjusted by various means provided by the manufacturer of the differential pressure regulator 309. The composition of the differential pressure regulator's source gas is selected such that it will not damage the microwave source 301 and will not interfere with system processes if small amounts leak by the window 304 into the bottom section 302b. For a microwave-regenerated adsorbent vessel that receives a flow of N₂+H₂+NH₃, either N₂ or H₂ or a mixture of N₂+H₂ are examples of appropriate overpressure gases. The top section 302a also connects to a gas outlet 313 with a flow restricting valve or orifice 314 and vent line 315 to allow the pressure in the top section 302a to drop if the differential pressure regulator 309 stops flowing gas. This may be necessary to maintain a constant differential pressure when the bottom section 302b pressure drops.

Other than the features described previously, the configuration of apparatus 300 is generally similar or identical to the apparatus 100 shown in FIG. 1. As with the apparatus 100 shown in FIG. 1 and described in greater detail above, various features of the apparatus 300 can be adjusted, such as the location, orientation, and number of the inlet and outlet ports 306/307, the shape, size and orientation of the adsorber vessel 302, etc.

Microwave Source Mounted Along Central Axis of Adsorbent Vessel

In some embodiments, the microwave source is located inside the adsorber vessel and along the central axis of the adsorber vessel so that multiple microwaves sources can be provided within the adsorbent material, thus allowing for full regeneration of the adsorbent material despite the adsorbent material being of arbitrary length.

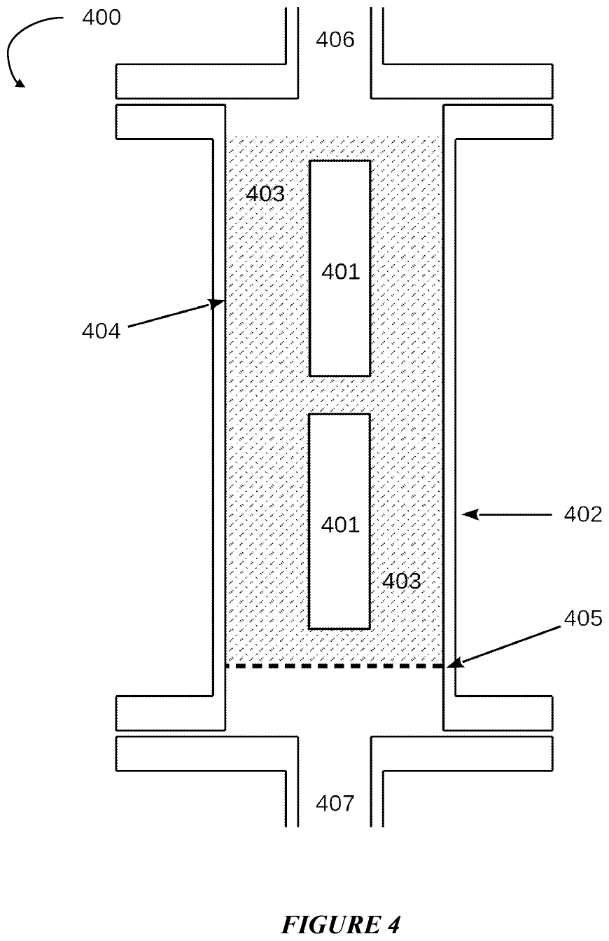

With reference to FIG. 4, apparatus 400 employs the above-described configuration wherein one or more microwave emitters 401 are mounted along the central axis of the adsorbent vessel 402. In the embodiment shown in FIG. 4, adsorbent material 403 is loaded in the adsorber vessel 402 around the microwave emitters 401 to thereby form a bed of adsorbent material 403. Process gas can enter the adsorber vessel 402 through an inlet port 406, travel through the bed of adsorbent material 403 that is loaded in the absorber vessel 402 and supported by a perforated plate 405, and exit the vessel 402 via an exit port 407. One or more microwave emitters 401 are located along the central axis of the adsorbent vessel 402. The microwave emitters 401 are surrounded by adsorbent material 403. The microwaves emitted by the microwave emitters 401 in a 360 degree fashion propagate radially through the adsorbent material 403, strike the adsorbent vessel wall 404, and are reflected back toward the emitter 401. In this manner, the microwaves can act to desorb NH3 from the absorbent material 403.

In some embodiments of the configuration shown in FIG. 4, the microwave power can at first be set to a relatively high value because it is being absorbed by the ammonia in the adsorbent material 403 and thus does not travel all the way back to the emitter 401 after it reflects off of the adsorbent vessel wall 404. As the ammonia is removed from the adsorbent material 403 and a substantial flux of reflected microwave power travels back to the emitter 401, the microwave power can be reduced to keep the reflected microwave flux reaching the emitter 401 below a desired limit.

Other than the features described previously, the configuration of apparatus 400 is generally similar or identical to the apparatus 100 shown in FIG. 1. As with the apparatus 100 shown in FIG. 1 and described in greater detail above, various features of the apparatus 400 can be adjusted, such as the location, orientation, and number of the inlet and outlet ports 406/407, the shape, size and orientation of the adsorber vessel 402, etc. Furthermore, while FIG. 4 illustrates two emitters 401, it should be appreciated that the number of emitters 401 is not limited, and that the emitters 401 can have any dimensions. In some embodiments, the apparatus 400 includes a single emitter 401 aligned with the central axis of the vessel 402 and which extends substantially the entire length of the vessel 402.

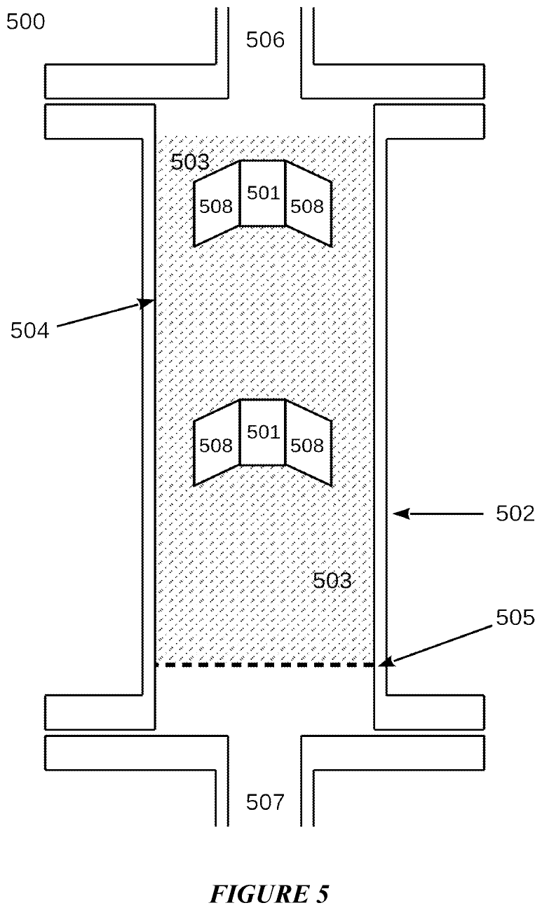

FIG. 5 depicts another embodiment of an apparatus 500 wherein microwave emitters are positioned along the central axis of the adsorber vessel. As shown in FIG. 5, an adsorber vessel 502 is equipped with an inlet port 506, a bed of adsorbent material 503 that is supported by a perforated plate 505, and an outlet port 507. Microwave emitters 501 are located on the central axis of the adsorber vessel 502. Launchers 508 are coupled to the emitters 501 to cause the microwaves to leave the launcher 508 with both radial and axial components of propagation. The launchers 508 generally encircle the emitters 501 such that microwave radiation emitted from the emitters 501 in any direction are subjected to the redirection of the launchers 508.

The launchers 508 can be fit with microwave-transparent windows to allow the microwaves to exit the launcher 508 while preventing the adsorbent material 503 from entering the launcher 508. In such embodiments, the launchers 508 or windows may have vent holes to allow pressure equalization between the interior of the launcher 508 and the adsorbent material 503.

Microwaves exiting the launcher 508 will reflect off of the adsorber vessel wall 504 and continue to propagate with both radial and axial components. This allows the microwave flux to travel down the length of the adsorbent vessel 502. If the microwave flux from one emitter 501 reaches the region of the next microwave emitter 501, it will reflect off of the exterior of the next emitter's launcher 508. In this way, emitters 501 are not subjected to microwave power from other emitters 501.

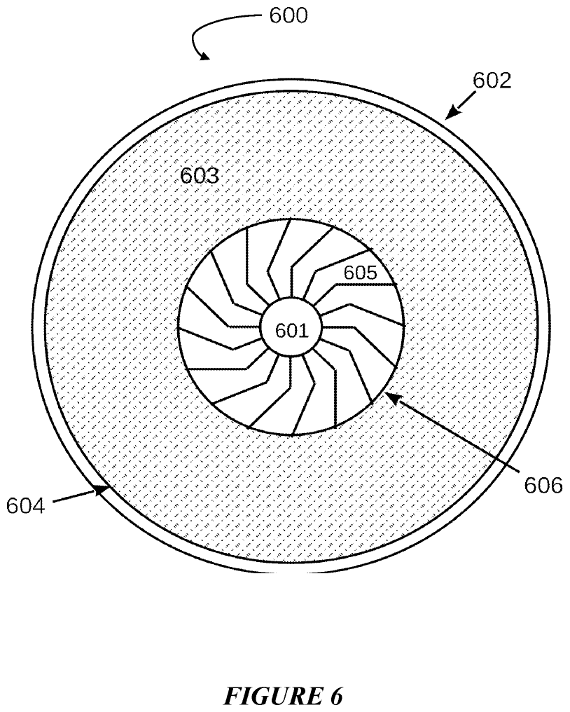

FIG. 6 depicts a top cross-sectional view of another embodiment of an apparatus 600 in which the microwave emitters 601 are coupled to launchers 605 that cause the microwaves to have a “rotational” propagation. The launchers 605 can be fit with microwave-transparent windows 606 to allow the microwaves to exit the launcher while preventing the adsorbent material 603 from entering the launcher 605. In such embodiments, the launchers 605 or windows 606 may have vent holes to allow pressure equalization between the interior of the launcher 605 and the adsorbent material 603. The microwaves will propagate through the adsorbent material 603 in the radial plane at an off-radial angle and reflect off of the vessel wall 604 at an off-radial angle. If the microwaves propagate back to the center of the vessel 602, they will reflect off of the exterior surface of the launcher 605 instead of reaching the emitter 601. In this way, the emitter 601 will not be exposed to reflected microwave power.

If the launchers are shaped to cause both rotational and axial propagation, the microwave paths will be a combination of the characteristics described above with respect to FIGS. 5 and 6. In this case, the microwaves will “swirl” through the bed of absorbent material. They will still reflect off of the adsorber vessel walls to propagate down the length of the adsorbent bed. If the microwaves reach the next emitter in the adsorbent bed, they will reflect off of the launcher for that emitter and thus downstream emitters will be protected from the upstream emitters' microwave power.

### EXAMPLES

### Example 1

A “microwave tube furnace” was built to demonstrate microwave desorption of NH₃ from type 13X adsorbent beads using a nitrogen sweep gas. The microwave tube furnace was built using a 1200 watt residential kitchen microwave oven turned on its side. The microwave oven was modified for lab use by removing the carousel, disconnecting its related drive mechanism, and cutting holes in the top and bottom of the microwave housing to allow a 2″ quartz tube to pass through the microwave cavity.

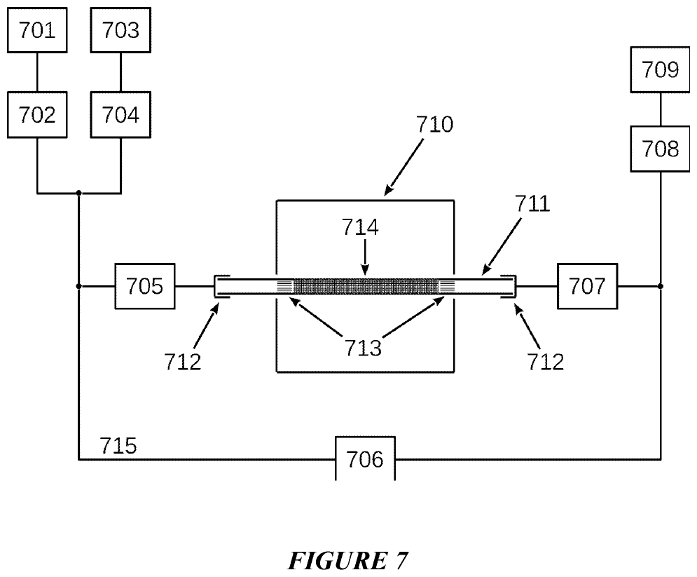

A diagram of the test apparatus is shown in FIG. 7. The microwave tube furnace includes a microwave oven 710 with a 2″ quartz tube 711 passing through it. Each end of the quartz tube 711 has a stainless steel 2″ o-ring compression to ¼″ ferrule compression fitting 712 to allow the quartz tube 711 to be connected to ¼″ gas lines. The central portion of the quartz tube 711 contains type 13X molecular sieve beads 714. The beads 714 are held in place by porous alumina plugs 713. The portion of the quartz tube 711 extending outside of the microwave oven 710 is wrapped with aluminum foil to prevent microwaves from leaking into the lab.

Gasses are supplied to the apparatus by cylinders of anhydrous ammonia 701 and nitrogen 703. The flow of each gas is regulated by a flow controller (702 and 704). The regulated flows of ammonia and nitrogen are teed into a common tube. The gas flow can be directed either through the quartz tube 711 or through a bypass 715 by properly configuring valves 705, 706, and 707. After passing through either of those routes, the gas flows through an ammonia detector 708 and is then directed to a flare 709 where any ammonia is combusted to nitrogen and water vapor.

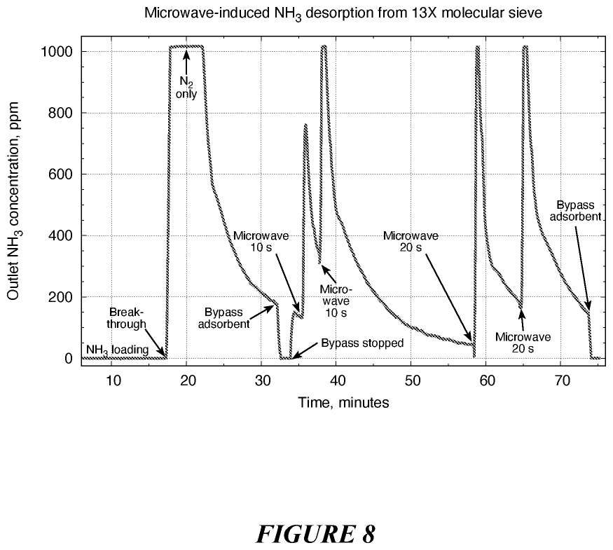

A flow of 4000 standard cubic centimeters per minute (sccm) N₂ and 300 sccm NH₃ were directed into the adsorbent bed 714. The concentration of NH₃ in the gas exiting the adsorbent bed 714 was monitored by a 0-1000 ppm infrared absorption detector 708. The outlet NH₃ concentration as a function of time is shown in FIG. 8. The outlet NH₃ concentration was zero until about 17 minutes into the experiment, at which time the NH₃ “broke through” the adsorption bed 714 and quickly reached an outlet concentration greater than the 1000 ppm limit of detector 708. At 18 minutes, the NH₃ flow was turned off and the N₂ flow was left on. At about 23 minutes, the outlet NH₃ concentration dropped below 1000 ppm and continued decreasing as the N₂ flow purged residual NH₃ from the bed 714 and tube 711. At 32 minutes the adsorbent bed 714 was bypassed via bypass 715 to allow pure N₂ to flow directly to the NH₃ sensor 708, which caused the sensor reading to drop to 0 ppm NH₃, confirming its zero calibration. At 34 minutes the nitrogen flow was directed back through the adsorption bed 714, causing the outlet NH₃ concentration to rise to about 120 ppm.

At 36 minutes, the microwaves of microwave 710 were turned on for 10 seconds. This caused the outlet NH₃ concentration to rapidly rise to 760 ppm and then start dropping again. At 38 minutes, the microwaves were turned on for another 10 seconds. This caused the outlet NH₃ concentration to rapidly increase above 1000 ppm and then drop as the microwaves were left off until about 58 minutes into the experiment.

At times 58 minutes and 64 minutes, microwaves were applied to the adsorbent bed 714 for 20 seconds. In each instance, the microwaves caused a rapid increase in the outlet NH₃ concentration to greater than 1000 ppm, followed by a rapid concentration decrease and then a slower concentration decrease.

At 74 minutes, the adsorbent bed 714 was bypassed via bypass 715 to direct pure N₂ to the NH₃ sensor to reconfirm its zero calibration.

Thermal images of the adsorbent bed were taken before and after the microwave testing. The thermal images indicated that there was non-uniform heating of the adsorbent bed 714. This was expected due to the microwave cavity not having a “stirrer” to prevent the formation of standing waves. The hottest regions of the bed 714 were below 100° C. Prior work with thermal regeneration of type 13X adsorbent has shown that there is very little NH₃ desorption at temperatures below 100° C. The rapid increases in outlet NH₃ concentration following short microwave exposures and the moderate temperature of the adsorbent bed after the testing indicates that the microwaves cause the NH₃ to desorb from the 13X surface by a non-thermal excitation. The rapid increase in NH₃ concentration indicates that microwave NH₃ desorption can be much faster than conventional thermal desorption processes.

### Example 2

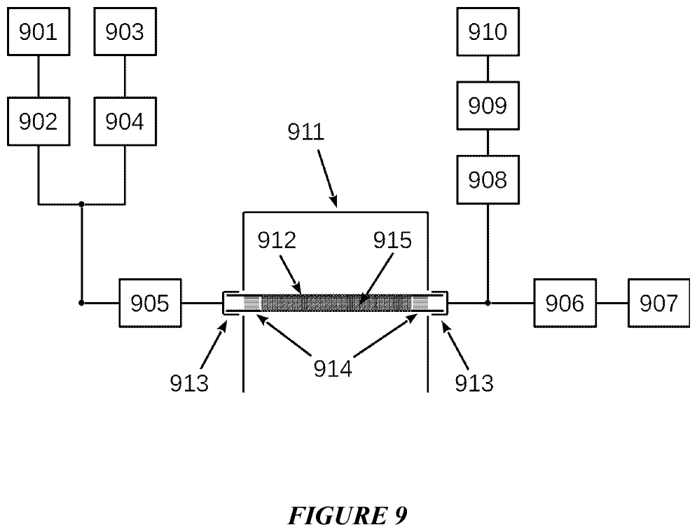

The microwave tube furnace from Example 1 was modified to demonstrate microwave NH₃ desorption and pure NH₃ collection using a vacuum pump. FIG. 9 shows a diagram of the modified apparatus. The apparatus comprises of a microwave oven 911 with a 2″ quartz tube 912 passing through it. Each end of the quartz tube 912 has a stainless steel 2″ o-ring compression to ¼″ ferrule compression fitting 913 to allow the quartz tube 912 to be connected to ¼″ gas lines. The quartz tube 912 was cut to a length that allowed the fittings 913 to be in contact with the microwave oven 911 housing, thus preventing microwave leakage into the lab. The central portion of the quartz tube 912 contains type 13X molecular sieve beads 915. The beads 915 are held in place by porous alumina plugs 914.

Gasses are supplied to the apparatus by cylinders of anhydrous ammonia 901 and nitrogen 903. The flow of each gas is regulated by a flow controller (902 and 904). The regulated flows of ammonia and nitrogen are teed into a common tube. A ball valve 905 can be closed to isolate the quartz tube 912 from the source gases 901/903. The output gas from the quartz tube 912 can be directed to either a flare 907 or a vacuum pump 909 by opening or closing ball valves 906 and 908. The exhaust from the vacuum pump 909 is captured by an accumulator bladder 910 to measure how much gas has been moved through the vacuum pump.

A 195.5 gram mass of 4 mm diameter 13X adsorbent beads (approximate volume of 250 mL) was placed in the center of the quartz tube. Porous alumina plugs were placed on both sides of the adsorbent beads to aid in keeping the beads packed tightly.

A nitrogen+ammonia gas flow containing 600 sccm ammonia was passed through the 13X beads for 8 minutes. During this time, the output from the bead bed was directed to the flare. The gas entering the flare was observed to see whether it burned or not. Nitrogen entering the flare will push the pilot flame to the side without burning, whereas an ammonia-containing gas entering the flare will create an additional flame with a characteristic orange color. No orange color was observed during the entire 8 minutes, indicating no breakthrough of ammonia from the adsorbent bed. The ammonia flow was shut off two times during the 8 minute period to see if stopping its flow while maintaining the nitrogen flow would affect the flare's pilot flame. The pilot flame was not disturbed by shutting off the ammonia, which indicates that no ammonia was exiting the bed; it was all being adsorbed by the 13X beads.

After the bed was loaded with 600 sccm of ammonia for eight minutes, the nitrogen and ammonia flows were shut off. The ammonia flow multiplied by the flow duration indicates that 4.8 standard liters of ammonia was adsorbed by the 13X beads. Ammonia adsorption is an exothermic process, and prior testing had shown that this amount of ammonia adsorption could raise the bead bed temperature to around 50° C. For this reason, the bed was allowed to cool for about 30 minutes.

After the cooling period, the upstream isolation valve 905 was closed, the tube 912 outlet was connected to the vacuum pump 909, and the vacuum pump 909 was turned on. The vacuum pump 909 transferred the residual gas from the tube 912 to the accumulator bladder 910. The calculated residual gas in the tube 912 was 0.5 L, which was consistent with the amount of gas transferred to the accumulator bladder 910. The accumulator bladder 910 stopped filling once the residual gas was removed from the tube 912, indicating that the system had no leaks and that the adsorbed ammonia was not desorbing from the 13X beads from vacuum alone.

The vacuum pump was left running and the microwave source 911 was turned on for one minute at a nominal 1200 W. During the microwave irradiation, the accumulator bladder 910 inflated to about 4 L by visual estimate. Immediately after irradiation, the quartz tube 912 was observed with an infrared camera. It indicated that most of the bed was 50° C. and one hot spot was about 85° C.

The vacuum 909 was turned off and the adsorbent bed 915 was allowed to cool for about ten minutes, then the process was repeated a second time. The vacuum 909 was turned on, and the microwave 911 activated at 1200 W. The accumulator bladder 910 showed no additional inflation after 40 s, indicating that no additional ammonia was being removed from the bed, so the microwave source was shut off at that time. Infrared camera observation after the second, 40 second irradiation indicated a 100° C. hot spot at the same location as the previous 85° C. hot spot. The higher temperature was likely due to incomplete cooling of the bed in the ten minute interval between the microwave cycles.

This experiment showed that microwave irradiation of 13X adsorbent can dramatically reduce ammonia desorption times. We estimate that over 80% of the adsorbed ammonia was desorbed by 60 seconds of microwave irradiation that heated the beads to no more than 85° C. Equivalent regeneration by temperature-pressure swing processing requires over an hour and a bed temperature over 250° C.

### Example 3

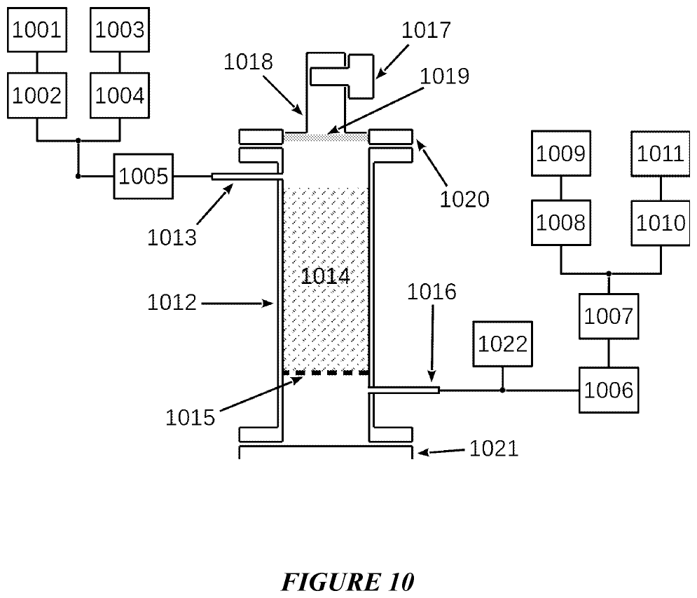

An ammonia adsorption bed was built as depicted in FIG. 10. The adsorption bed had the general configuration of the apparatus 100 described previously with respect to FIG. 1. The adsorber vessel body 1012 was a 4″ schedule 40 carbon steel pipe with flanges on each end. A window flange 1020 with a borosilicate glass window 1019 was attached to the upper end of the adsorber vessel body 1012. A gas inlet tube 1013 was welded to the upper end of the adsorber vessel body 1012. A perforated sheet metal plate 1015 with a hexagonal pattern of 0.0625″ holes with 0.094″ center-to-center separations was welded to the interior of the adsorber vessel body 1012 to support the adsorbent beads 1014. A blank flange 1021 was attached to the lower adsorber vessel 1012 flange. A gas outlet tube 1016 was welded to the lower end of the adsorber vessel body 1012 below the perforated sheet metal plate 1015.

Gasses are supplied to the apparatus by cylinders of anhydrous ammonia 1001 and nitrogen 1003. The flow of each gas is regulated by a flow controller (1002 and 1004). The regulated flows of ammonia and nitrogen are teed into a common tube. A ball valve 1005 can be closed to isolate the adsorber vessel 1012 from the source gases 1001/1003. Gas leaving the adsorber vessel 1012 via the gas outlet tube 1016 passes by a pressure gauge 1022 and then through an isolation valve 1006 to a vacuum pump 1007. The exhaust from the vacuum pump can be directed to either a flare 1009 or an accumulator bladder 1011 by opening or closing ball valves 1008 and 1010. The accumulator bladder 1011 provides a way to measure how much gas has been moved through the vacuum pump.

The adsorber vessel 1012 was loaded with 2200 g (3.5 L) of 4 mm diameter type 13X adsorbent beads. The vessel 1012 was isolated from its source gases 1001/1003 and its interstitial gas was removed with the vacuum pump 1007 and exhausted to the flare 1009. The adsorber vessel 1012 was isolated from the vacuum pump 1007 and reconnected to the source gas manifold. Ammonia gas was flowed into the adsorber vessel 1012 until the vessel pressure reached 0 psig (atmospheric pressure) so as to fully load the adsorbent beads 1014 with ammonia. The interstitial ammonia gas was removed with the vacuum pump 1007 and exhausted to the flare 1009. The vacuum pump 1007 exhaust was then directed to the accumulator bladder 1011, which was previously measured to have a 29 L gas capacity.

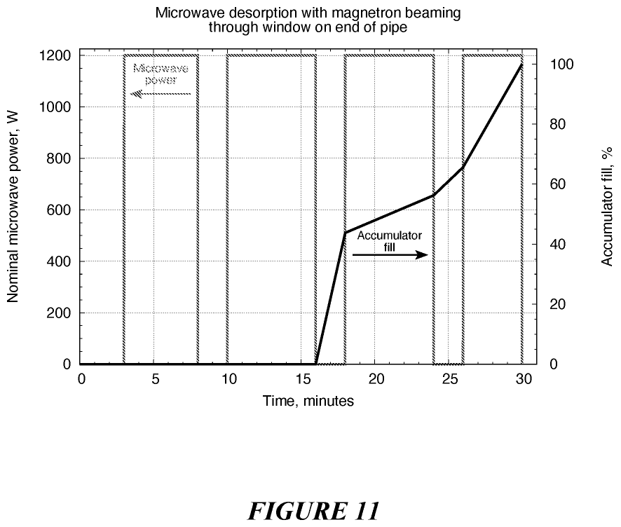

FIG. 11 shows the accumulator fill percentage and nominal microwave power during the 30 minute microwave-induced desorption test. The microwave source 1017 was off (0 watts) during the first 3 minutes of the test. During this time, the accumulator bladder 1011 did not fill, indicating that the system had no leaks and that the ammonia could not be removed solely by vacuum. The microwave source 1017 was turned on (1200 W) for 4-6 minute periods and then turned off (0 W) for two minutes to cool off starting at minute 3 of the test. The accumulator bladder 1011 was observed to start filling after approximately 11 minutes of microwave exposure. Once ammonia began coming out of the adsorber vessel 1012, it continued to do so during the periods when the microwave source 1017 was turned off. The accumulator bladder 1011 was full at the end of a 30 minute period that consisted of 21 minutes of the microwave source being on and 9 minutes of it being off.

### Example 4

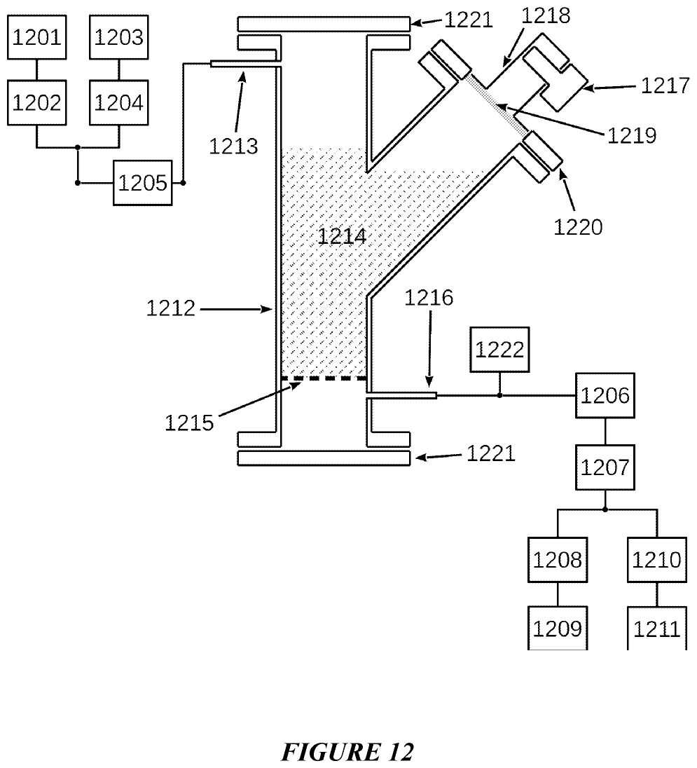

An ammonia adsorption bed was built as depicted in FIG. 12. The adsorber vessel body 1212 was a 4″ schedule 40 carbon steel pipe with blank flanges 1221 on each end. A window flange 1220 with a borosilicate glass window 1219 was attached to a pipe section that met the main adsorber vessel 1212 body at a 45 degree angle. A gas inlet tube 1213 was welded to the upper end of the adsorber vessel body 1212. A perforated sheet metal plate 1215 with a hexagonal pattern of 0.0625″ holes with 0.094″ center-to-center separations was welded to the interior of the adsorber vessel body 1212 to support the adsorbent beads 1214. A gas outlet tube 1216 was welded to the lower end of the adsorber vessel body 1212 below the perforated sheet metal plate 1215.

Gasses are supplied to the apparatus by cylinders of anhydrous ammonia 1201 and nitrogen 1203. The flow of each gas is regulated by a flow controller (1202 and 1204). The regulated flows of ammonia and nitrogen are teed into a common tube. A ball valve 1205 can be closed to isolate the adsorber vessel 1212 from the source gases. Gas leaving the adsorber vessel 1212 via the gas outlet tube 1216 passes by a pressure gauge 1222 and then through an isolation valve 1206 to a vacuum pump 1207. The exhaust from the vacuum pump can be directed to either a flare 1209 or an accumulator bladder 1211 by opening or closing ball valves 1208 and 1210. The accumulator bladder 1211 provides a way to measure how much gas has been moved through the vacuum pump.

The adsorber vessel 1212 was loaded with 2200 g (3.5 L) of 4 mm diameter type 13X adsorbent beads. The vessel 1212 was isolated from its source gases 1201/1203 and its interstitial gas was removed with the vacuum pump 1207 and exhausted to the flare 1209. The adsorber vessel 1212 was isolated from the vacuum pump 1207 and reconnected to the source gas manifold. Ammonia gas was flowed into the adsorber vessel 1212 until the vessel pressure reached 0 psig (atmospheric pressure) so as to fully load the adsorbent beads 1214 with ammonia. The interstitial ammonia gas was removed with the vacuum pump 1207 and exhausted to the flare 1209. The vacuum pump exhaust was then directed to the accumulator bladder 1211, which was previously measured to have a 29 L gas capacity.

While the vacuum pump 1207 was running, the 1200 W microwave source 1217 was turned on for 5 minutes, allowed to cool for 3.5 minutes, then turned on for 5.5 minutes. The accumulator bladder 1211 was filled with ammonia at the end of this 14 minute period that consisted of 10.5 minutes of the microwave source 1217 being on and 3.5 minutes of it being off. This 45 degree angle configuration took half as much time to remove 29 L of ammonia from the adsorbent bed 1214 as the straight-on configuration shown in FIG. 10 and described in Example 3.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. A method for desorbing ammonia from an adsorbent material comprising:
providing an adsorbent material having ammonia adsorbed therein; and
exposing the adsorbent material to microwave radiation to thereby desorb ammonia from the adsorbent material.

2. The method of claim 1 further comprising:
passing a sweep gas though the adsorbent material to thereby remove desorbed ammonia from the adsorbent material.

3. The method of claim 1 further comprising:
removing a pure stream of desorbed ammonia from the adsorbent material by subjecting the adsorbent material to a vacuum pump.

4. The method of claim 1, wherein the adsorbent material is one or more of 4A, 5A, or 13X zeolites.

5. The method of claim 1, wherein exposing the adsorbent material to microwave radiation to thereby desorb ammonia from the adsorbent material comprises:
exposing the adsorbent material to microwave radiation having a first photon energy; and
exposing the adsorbent material to microwave radiation having a second photon energy, the second photon energy being greater than the first photon energy.

6. The method of claim 1, wherein providing an adsorbent material having ammonia adsorbed therein comprises:
passing a gas mixture through the adsorbent material, the gas mixture comprising H₂, N₂ and ammonia, wherein the adsorbent material selectively adsorbs the ammonia while allowing a mixture of H₂ and N₂ to pass through the adsorbent material.

7. The method of claim 6, further comprising:
directing the mixture of H₂ and N₂ that passes through the adsorbent material to an electrochemical purifier to thereby produce high purity H₂ at the outlet of the electrochemical purifier, and
directing the high purity H₂ to an electrochemical compressor to thereby produce high pressure, high purity H₂ at the outlet of the electrochemical purifier outlet.

8. The method of claim 7 wherein the electrochemical purifier and the electrochemical compressor are proton exchange membrane devices.

9. The method of claim 6, further comprising:
cracking ammonia to form the gas mixture comprising H₂, N₂ and ammonia.

10. The method of claim 1, further comprising:
removing desorbed ammonia from the adsorbent material; and
directing, via a pump, the removed ammonia to an ammonia cracker.

11. The method of claim 10, wherein providing an adsorbent material having ammonia adsorbed therein comprises:
passing an output stream from an ammonia cracker through the adsorbent material, the output stream comprising a residual amount of uncracked ammonia.

12. The method of claim 11, wherein exposing the adsorbent material to microwave radiation to thereby desorb ammonia from the adsorbent material comprises:
periodically exposing the adsorbent material to microwave radiation.

13. An apparatus for removing ammonia from an adsorbent material, comprising:
an adsorbent vessel;
an adsorbent material disposed within the adsorbent vessel, the adsorbent material having ammonia adsorbed therein; and
a microwave emitter configured to direct microwave radiation at the adsorbent material disposed in the adsorbent vessel.

14. The apparatus of claim 13, wherein the microwave emitter is located outside of the adsorbent vessel.

15. The apparatus of claim 14, wherein the adsorbent vessel further comprises:
a microwave transparent window, wherein the microwave emitter is configured to direct microwave radiation into the adsorbent vessel through the microwave transparent window.

16. The apparatus of claim 14, wherein the apparatus further comprises:
one or more angled pipe sections extending from the adsorbent vessel;
wherein a microwave emitter is positioned proximate a terminal end of each of the one or more angled pipe sections; and
wherein each of the one or more angled pipe sections is configured to direct microwave radiation into the adsorbent vessel such that the microwave radiation propagates down the length of the adsorbent vessel.

17. The apparatus of claim 13, wherein the microwave emitter is disposed inside the adsorbent vessel.

18. The apparatus of claim 17, wherein the adsorbent vessel is partitioned into an upper portion and a lower portion, and the microwave emitter is disposed in the upper portion such that the microwave is isolated from the lower portion.

19. The apparatus of claim 17, wherein the microwave emitter comprises a plurality of microwave emitters, and the plurality of microwave emitters are positioned along a central axis of the adsorbent vessel.

20. The apparatus of claim 19, further comprising:
a launcher associated with each of the plurality of microwave emitters, the launchers being configured to direct microwave radiation emitted by the microwave emitters in a rotational, axial, or combination of rotational and axial directions.
